(19) United States
(12) Patent Application Publication
(10) Pub. No.: US 2017/0155457 A1
(43) Pub. Date: Jun. 1, 2017

(54) SYNCHRONIZATION DETECTION METHOD AND TRANSMISSION APPARATUS

(71) Applicant: FUJITSU LIMITED, Kawasaki-shi (JP)

(72) Inventor: Shota Shinohara, Kawasaki (JP)

(73) Assignee: FUJITSU LIMITED, Kawasaki-shi (JP)

(21) Appl. No.: 15/271,654

(22) Filed: Sep. 21, 2016

(30) Foreign Application Priority Data
Nov. 27, 2015 (JP) 2015-232323

(51) Int. Cl. H04J 3/06; H04L 12/26

(52) U.S. Cl. CPC H04J 3/0658; H04L 43/16

(57) ABSTRACT

A synchronization detection method executed by a processor included in a transmission apparatus, the synchronization detection method includes receiving a frame in accordance with a predetermined timing; calculating an unmatched bit number that indicates a number of unmatched bits between a bit stream of the received frame and an expected bit stream that indicates a bit stream that has been expected to be received; acquiring an accumulated number by accumulating the unmatched bit number at the predetermined timing; determining whether the received frame is synchronized with a predetermined signal by comparing the accumulated number and a predetermined threshold; and starting processing for establishing synchronization between the received frame and the predetermined signal when it is determined that the received frame is not synchronized with the predetermined signal.

### CROSS-REFERENCE TO RELATED APPLICATION

This application is based upon and claims the benefit of priority of the prior Japanese Patent Application No. 2015-232323, filed on Nov. 27, 2015, the entire contents of which are incorporated herein by reference.

### FIELD

The embodiments discussed herein are related to a synchronization detection method and a transmission apparatus.

### BACKGROUND

In a synchronized state of frame data (in frame (IF)), when bit errors of frame data continues over a plurality of pieces of frame data and for a predetermined number of times (for example, five times) in succession, or when a synchronization phase of a frame being received is changed, a receiving apparatus determines synchronization loss of the frame data. When synchronization loss (out of frame (OOF)) is determined, the receiving apparatus shifts the status thereof from “IF” to “OOF” and starts up synchronization pull-in processing for establishing synchronization of frame data. Accordingly, when the synchronization phase of the frame of the frame data is displaced, OOF is desirably determined, originally. As related arts, Japanese Laid-open Patent Publication No. 11-122233, Japanese Laid-open Patent Publication No. 9-130741, and Japanese Laid-open Patent Publication No. 2007-267085 are disclosed, for example.

However, in a receiving apparatus, even in the case of a bit error of only one bit in a bit stream within the frame data, for example, the error is counted as a bit error. With this, when the count value exceeds a predetermined number of times, even if no change of the frame phase actually occurs, the status of the frame data shifts to OOF in some cases.

The receiving apparatus also has a function of correcting a bit error in frame data using forward error correction (FEC). However, when the status is OOF, the FEC function is unusable. With this, when the state in which the status is OOF frequently occurs, the state in which the FEC function is unusable also frequently occurs, whereby the data transmission efficiency is lowered.

For this reason, in the receiving apparatus, it is conceivable to increase the predetermined number of times for determining that the status has shifted to OOF in order to avoid a shift to OOF due to a minor bit error. However, this makes it difficult to shift the status to OOF when OOF actually occurs. As a result, even when change of the frame phase actually occurs, a shift to OOF is delayed.

An aspect is to provide a receiving apparatus and a synchronization detection method with which synchronization loss may be detected with high accuracy.

### SUMMARY

According to an aspect of the invention, a synchronization detection method executed by a processor included in a transmission apparatus, the synchronization detection method includes receiving a frame in accordance with a predetermined timing; calculating an unmatched bit number that indicates a number of unmatched bits between a bit stream of the received frame and an expected bit stream that indicates a bit stream that has been expected to be received; acquiring an accumulated number by counting the unmatched bit number at the predetermined timing; determining whether the received frame is synchronized with a predetermined signal by comparing the accumulated number and a predetermined threshold; and starting processing for establishing synchronization between the received frame and the predetermined signal based on a synchronization pattern in the bit stream of the received frame, when it is determined that the received frame is not synchronized with the predetermined signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a transmission system according to a first embodiment;

FIG. 2 is a block diagram illustrating an example of a configuration in a transmission apparatus according to the first embodiment;

FIG. 3 is an explanatory diagram illustrating an example of a format configuration of a frame;

FIG. 4 is a block diagram illustrating an example of a configuration in a first synchronization determination unit;

FIG. 5 is an explanatory diagram illustrating an example of a state shift of a state machine;

FIG. 6 is a flowchart illustrating an example of a processing operation of the first synchronization determination unit related to first synchronization monitoring processing;

FIG. 7 is a timing diagram illustrating an example of each signal in the first synchronization determination unit at the time of synchronization pull-in according to the first embodiment;

FIG. 8 is a timing diagram illustrating an example of each signal in the first synchronization determination unit at the time of OOF according to the first embodiment;

FIG. 9 is a block diagram illustrating an example of a configuration in a second synchronization determination unit according to a second embodiment;

FIG. 10 is an explanatory diagram illustrating an example of a state shift of a state machine;

FIG. 11 is a flowchart illustrating an example of a processing operation of the second synchronization determination unit related to second synchronization monitoring processing;

FIG. 12 is a timing diagram illustrating an example of each signal in the second synchronization determination unit at the time of synchronization pull-in according to the second embodiment; and

FIG. 13 is an explanatory diagram illustrating an example of a relation between a BER before FEC correction and an OOF occurrence interval.

### DESCRIPTION OF EMBODIMENTS

Hereinafter, with reference to the drawings, embodiments of a receiving apparatus and a synchronization detection method disclosed by the present application will be described in detail. These embodiments are not intended to limit the disclosed techniques. The embodiments described below may be combined as appropriate in a range in which no contradiction is generated.

### First Embodiment

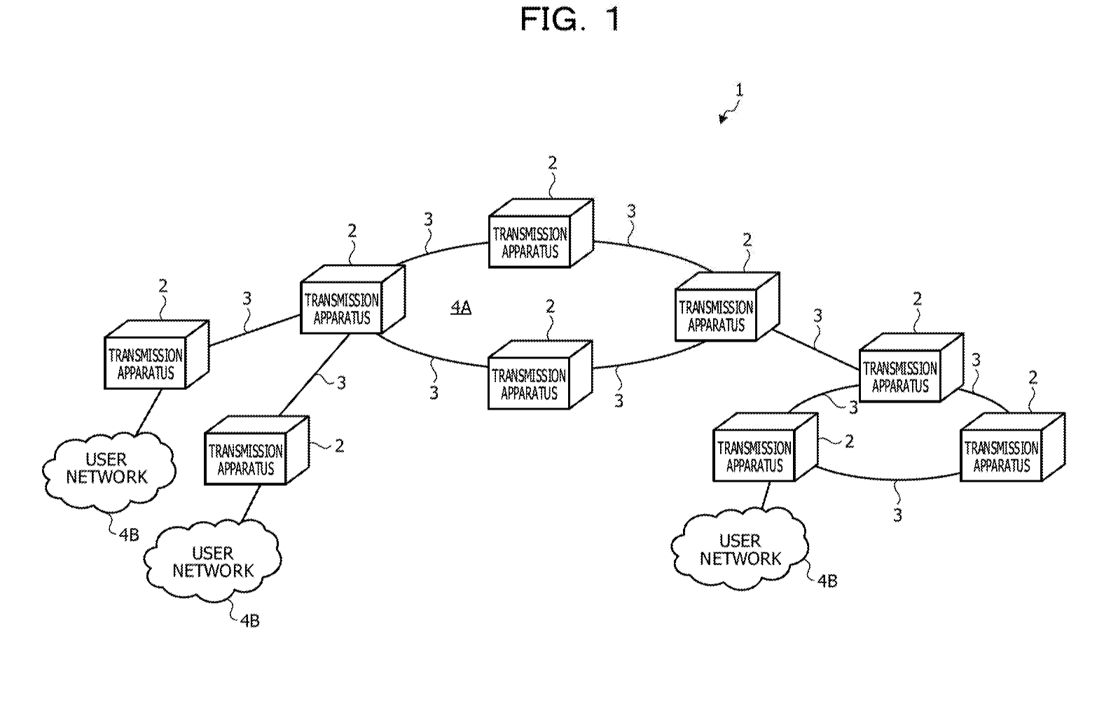

FIG. 1 is an explanatory diagram illustrating an example of a transmission system 1 according to a first embodiment. The transmission system 1 illustrated in FIG. 1 includes a plurality of transmission apparatuses 2. Each of the transmission apparatuses 2 is connected to an optical network 4A using an optical fiber 3 or other as medium or a user network 4B using an electric line or other as medium, for example. The optical network 4A is a network such as optical transport network (OTN) and synchronous optical network (SONET)/synchronous digital hierarchy (SDH), for example. The user network 4B is a network such as Ethernet®, for example. Each transmission apparatus 2 is connected to a transmission apparatus 2 on an opposite side thereof with the optical fiber 3 and transmits an OTN frame, for example.

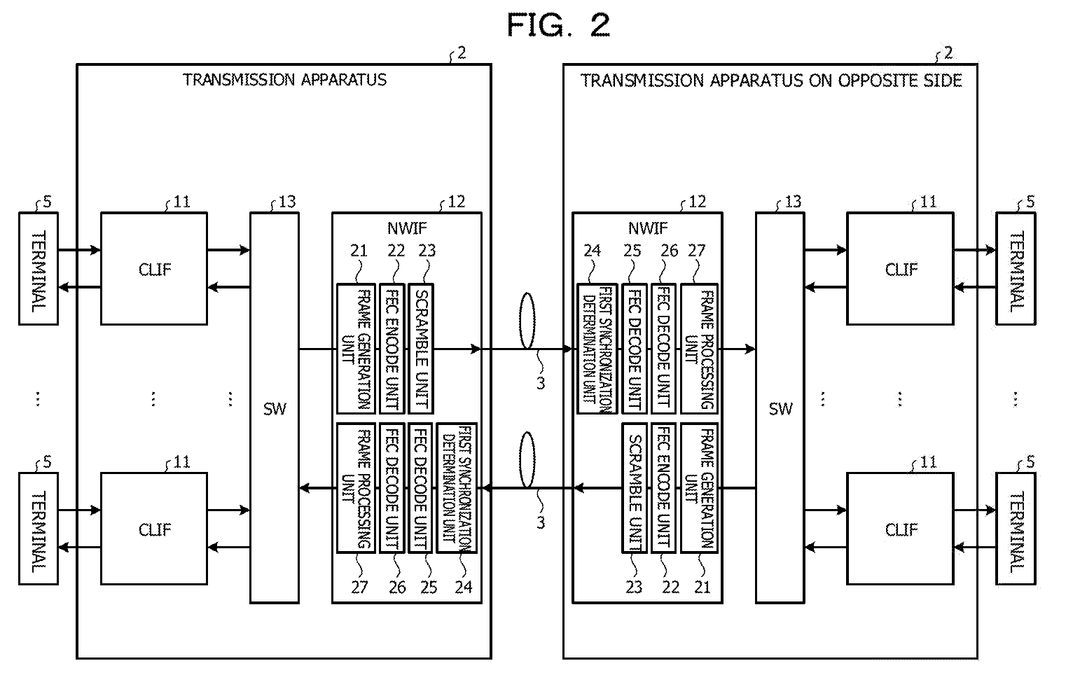

FIG. 2 is a block diagram illustrating an example of a configuration in a transmission apparatus 2 according to the first embodiment. For the convenience of explanation, the transmission apparatus 2 will be described. However, the transmission apparatus 2 on the opposite side thereof has substantially the same configuration and thus is denoted with the same reference numeral, and the overlapped explanation for the configuration and operation thereof will be omitted.

The transmission apparatus 2 includes a client interface (CLIF) 11, a network interface (NWIF) 12, and a switch (SW) 13. The CLIF 11 is, for example, a communication IF that administers communication with an electric line connected to a terminal 5 in the user network 4B. The NWIF 12 is a communication IF that administers communication with the optical fiber 3 in the optical network 4A. The SW 13 is a switch that switchably connects communication between the CLIF 11 and the NWIF 12, or between each of the CLIFs 11.

The NWIF 12 includes a frame generation unit 21, an FEC encode unit 22, a scramble unit 23, a first synchronization determination unit 24, a descramble unit 25, an FEC decode unit 26, and a frame processing unit 27. The frame generation unit 21 is, for example, a generation unit that assembles frames such as OTN frames. The FEC encode unit 22 adds FEC into a frame. The scramble unit 23 is a processing unit that scrambles the entire frame.

The first synchronization determination unit 24 is a determination unit that determines a synchronization state of a synchronization pattern in a reception frame, for example, IF or OOF. Cases where the synchronization determination is shifted to OOF includes a first case where a reception frame has disappeared, a second case where the phase of a reception frame is displaced, and a third case where a bit error rate (BER) is high on a transmission path such as the optical fiber 3. The first case is, for example, a case where a reception frame itself is hard to receive due to causes such as disconnection of a transmission path or failure of the transmission apparatus 2 on an opposite side, whereby an OOF state continues. The second case is a case where although reception frames are received, due to causes such as switching of frame data of the transmission apparatus 2 on an opposite side or the influence of a jitter component of a transmission path, the frame is received at a timing deviated from a timing of an IF state that has already been established. In the second case, extractions of overhead information and client data from reception frames are disabled. The third case is a case where although no timing deviation is present in receiving reception frames and an IF state is kept, the transmission path quality (line quality) is deteriorated and a bit error is thus generated.

The descramble unit 25 is a processing unit that cancels scrambling of reception frames that have been scrambled. The FEC decode unit 26 is a processing unit that corrects a bit error with respect to a bit stream in a reception frame using FEC in the reception frame. The frame processing unit 27 is a processing unit that disassembles the reception frame corrected by the FEC decode unit 26.

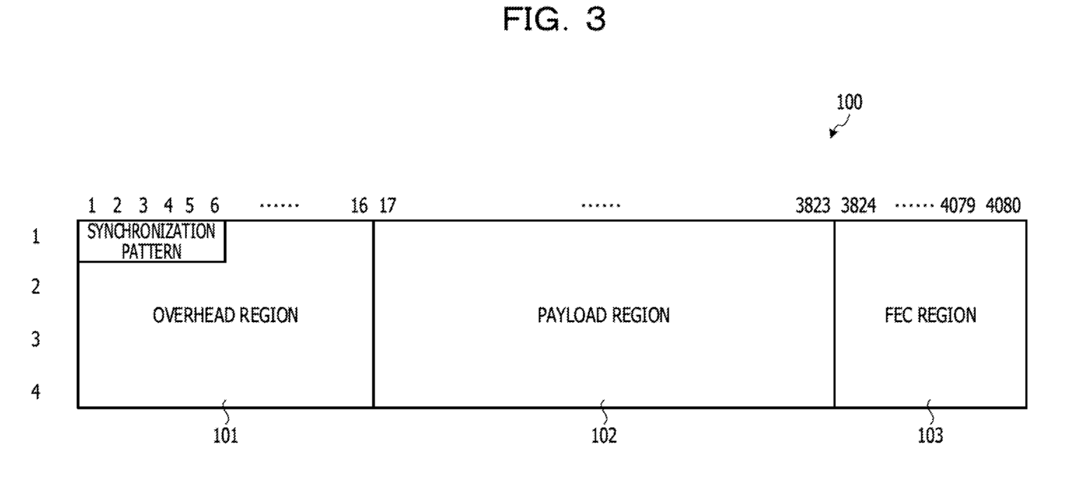

FIG. 3 is an explanatory diagram illustrating an example of a format configuration of a frame 100. The frame 100 illustrated in FIG. 3 corresponds to an OTN frame. The frame 100 includes an overhead region 101, a payload region 102, and an FEC region 103. The frame 100 is composed of 4 rows×4080 bytes. Transmission is performed in the order of 1st to 4080th bytes in the 1st row, 1st to 4080th bytes in the 2nd row, 1st to 4080th bytes in the 3rd row, and 1st to 4080th bytes in the 4th row. An overhead region 101 is, for example, a region for storing therein an administering function or a monitoring function, in particular, a synchronization pattern among the transmission apparatuses 2. The synchronization pattern is a pattern specified by a predetermined bit stream for the transmission apparatus 2 at the reception side to acknowledge the head of the frame. The payload region 102 is, for example, a region for storing therein client data. The FEC region 103 is a region for storing FEC of the frame.

The frame generation unit 21 in the NWIF 12 causes the overhead region 101 in the frame 100 to store therein the synchronization pattern or the administering function, causes the payload region 102 in the frame 100 to store therein the client data, and causes the FEC region 103 in the frame 100 to store therein FEC. The frame generation unit 21 generates frame data. The NWIF 12 continuously transmits the frame 100 to the optical fiber 3 with a predetermined frame cycle specified by the OTN standard. The NWIF 12 acknowledges the synchronization pattern in the reception frame and thereby determines the synchronization state of the frame data, that is, whether the state is IF or 00F. The NWIF 12 then outputs a frame timing in the state of IF to the descramble unit 25, the FEC decode unit 26, and the frame processing unit 27. The descramble unit 25, based on the frame timing in the state of IF, performs descrambling processing of the reception frame. Furthermore, the FEC decode unit 26, based on the frame timing in the state of IF, performs error correction of a bit stream in the reception frame. Furthermore, the frame processing unit 27, based on the frame timing in the state of IF, extracts the overhead information from the overhead region 101 in the frame 100 and extracts the client data from the payload region 102 in the frame 100.

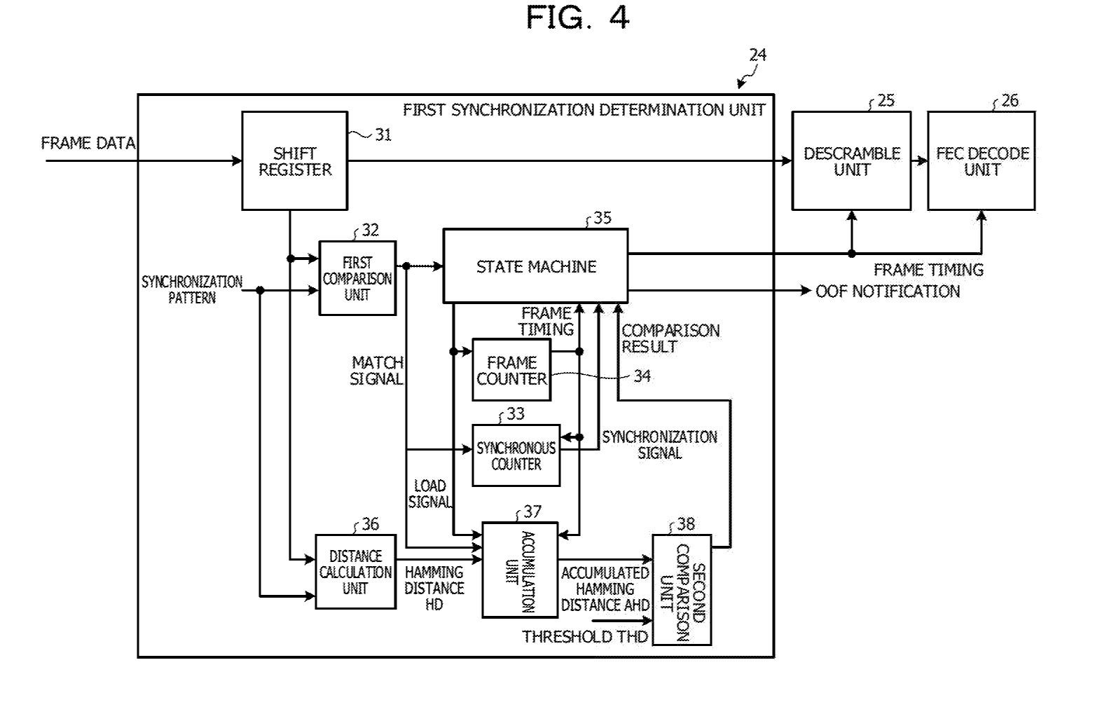

FIG. 4 is a block diagram illustrating an example of a configuration in the first synchronization determination unit 24. The first synchronization determination unit 24 illustrated in FIG. 4 includes a shift register 31, a first comparison unit 32, a synchronous counter 33, a frame counter 34, a state machine 35, a distance calculation unit 36, an accumulation unit 37, and a second comparison unit 38. The distance calculation unit 36 and the accumulation unit 37 are calculation units. The second comparison unit 38 is a determination unit. The state machine 35 is, for example, a determination unit and a control unit.

The shift register 31 shifts a bit stream in the reception frame bit by bit and converts the shifted bit stream into a bit stream with the same width as that of the synchronization pattern. The shift register 31 then outputs that bit stream to the descramble unit 25, the first comparison unit 32, and the distance calculation unit 36. The first comparison unit 32 compares a bit stream of the synchronization pattern in the reception frame and an expected value of a predetermined synchronization pattern. The first comparison unit 32 has a region for storing therein the predetermined synchronization pattern. When the bit stream and the expected value perfectly match each other, the first comparison unit 32 outputs a pulse of a match signal to the state machine 35, the synchronous counter 33, and the accumulation unit 37.

The synchronous counter 33 is a counter that counts detection of a synchronization pattern in accordance with the match signal. The frame counter 34 is a counter that starts a count operation of the frame timing of the reception frame in accordance with the match signal from the first comparison unit 32. The frame timing is, for example, a head timing of the reception frame in the predetermined cycle specified by the OTN standard. The frame counter 34 outputs the frame timing to the synchronous counter 33, the state machine 35, and the distance calculation unit 36. For example, at the time of synchronization pull-in, when the first match signal is input and then the next match signal is input at a timing the next frame timing is input, the synchronous counter 33 outputs a synchronization signal for shifting the synchronization determination to IF to the state machine 35. The next match signal becomes a match signal delayed by one clock from the timing at which a match signal is detected.

The distance calculation unit 36 compares a bit stream of the synchronization pattern in the reception frame and an expected value of a predetermined synchronization pattern from the shift register 31. The distance calculation unit 36 then calculates the unmatched bit number between the bit stream and the expected value, that is, a hamming distance HD. The accumulation unit 37 accumulates the hamming distance HD acquired at the distance calculation unit 36 for each frame timing and calculates an accumulated hamming distance AHD obtained by the accumulation. The accumulation unit 37 has a region for storing therein the accumulated hamming distance AHD. The accumulation unit 37 resets the accumulated hamming distance AHD being stored in accordance with a load signal from the state machine 35.

The second comparison unit 38 determines whether the accumulated hamming distance AHD has exceeded a threshold THD. The threshold THD is the hamming distance HD with which the synchronization state of the reception frame is determined as 00F, for example, 7 times. The second comparison unit 38 has a region for storing therein the threshold THD. The second comparison unit 38 outputs a comparison result when the accumulated hamming distance AHD has exceeded the threshold THD to the state machine 35.

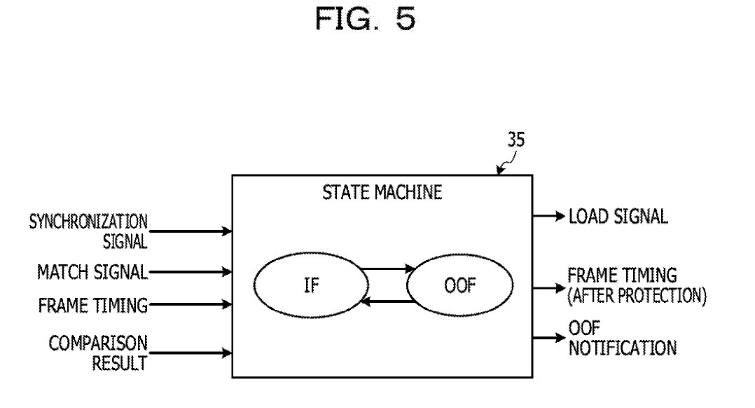

FIG. 5 is an explanatory diagram illustrating an example of a state shift of the state machine 35. When the state machine 35 illustrated in FIG. 5 detects a synchronization signal from the synchronous counter 33, the state machine 35 shifts the synchronization determination of the reception frame to IF and outputs a load signal to the frame counter 34 and the accumulation unit 37. When the state machine 35 detects a comparison result in a case where the accumulated hamming distance AHD has exceeded the threshold THD, the state machine 35 shifts the synchronization determination of the reception frame to OOF and outputs an OOF notification thereof. When the state machine 35 detects a comparison result in a case where the accumulated hamming distance AHD has not exceeded the threshold THD, the state machine 35 continues IF as the synchronization determination of the reception frame.

When the synchronization determination is shifted to 00F, the first synchronization determination unit 24 starts the synchronization pull-in operation again. Furthermore, when the first synchronization determination unit 24 detects a synchronization signal from the synchronous counter 33, the first synchronization determination unit 24 shifts the synchronization determination of the reception frame to IF. When the synchronization determination is IF, as long as the bit stream of the synchronization pattern in the reception frame and the expected value perfectly match each other at the first comparison unit 32, the first synchronization determination unit 24 continues IF as the synchronization determination.

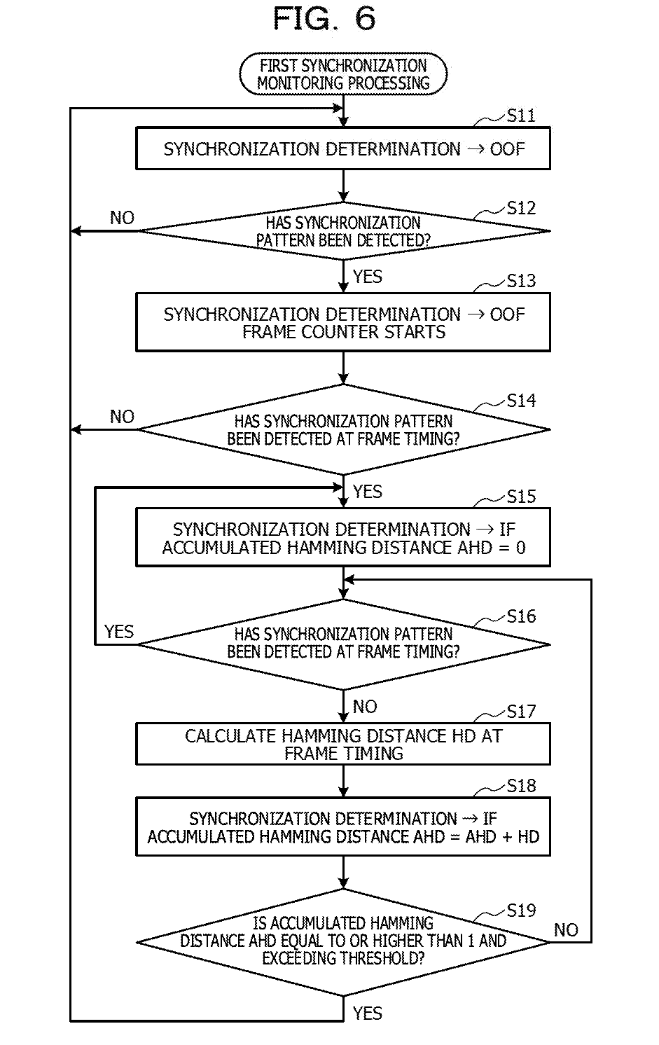

Next, an operation of the transmission system 1 according to the first embodiment will be described. FIG. 6 is a flowchart illustrating an example of a processing operation of the first synchronization determination unit 24 related to first synchronization monitoring processing. The first synchronization monitoring processing is processing for detecting the synchronization pattern, accumulating the hamming distance HD of the synchronization pattern, and when the accumulated hamming distance AHD has exceeded a predetermined threshold THD, shifting the synchronization determination to OOF. The state machine 35 of the first synchronization determination unit 24 illustrated in FIG. 4 is at the time of synchronization pull-in in the initial state thereof. With this, the synchronization determination is to be OOF (S11), and whether the synchronization pattern has been detected is determined (S12). The processing for determining whether the synchronization pattern has been detected is performed with the first comparison unit 32 determining whether a bit stream of the synchronization pattern in the reception frame and an expected value of the synchronization pattern perfectly match each other. When the perfect match is determined, it is determined that the synchronization pattern has been detected.

When the synchronization pattern has been detected (Yes at S12), the state machine 35 sets the synchronization determination to OOF. The state machine 35 then starts a count operation of the frame timing at the frame counter 34 (S13). The state machine 35 determines whether the synchronization pattern has been detected at the frame timing at the frame counter 34 (S14).

When the synchronization pattern has been detected at the frame timing (Yes at S14), the state machine 35 determines that the synchronization pattern has been detected twice continuously, and sets the synchronization determination to IF and sets the accumulated hamming distance AHD to 0 C(S15). Furthermore, the state machine 35 determines whether the synchronization pattern has been detected at the frame timing at the frame counter 34 (S16).

When the synchronization pattern has not been detected at the frame timing (No at S16), the state machine 35 calculates the hamming distance HD of the synchronization pattern of the frame timing (S17). The distance calculation unit 36 calculates the hamming distance HD between the bit stream of the synchronization pattern of the frame timing in the reception frame and the expected value of the predetermined synchronization pattern. The state machine 35 sets the synchronization determination to IF and accumulates the hamming distance HD of the synchronization pattern on the accumulated hamming distance AHD (S18). The state machine 35 then determines whether the accumulated hamming distance AHD is equal to or higher than 1 and has exceeded the threshold THD (S19).

When the accumulated hamming distance AHD is equal to or higher than 1 and has exceeded the threshold THD (Yes at S19), the state machine 35 moves to S11 in order to shift the synchronization determination to OOF. As a result, the state machine 35 shifts synchronization determination to OOF because the accumulated hamming distance AHD has exceeded the threshold THD. When the accumulated hamming distance AHD is equal to or higher than 1 and has not exceeded the threshold THD (No at S19), the state machine 35 moves to S16 in order to determine whether the synchronization pattern has been detected at the frame timing. As a result, the state machine 35 continues IF as the synchronization determination even in the third case where a minor bit error occurs because the accumulated hamming distance AHD has not exceeded the threshold THD.

When the synchronization pattern has not been detected (No at S12), the state machine 35 moves to S11 in order to shift the synchronization determination to OOF. When the synchronization pattern has not been detected at the frame timing (No at S14), the state machine 35 moves to S11 in order to shift the synchronization determination to OOF.

When the synchronization pattern has been detected at the frame timing (Yes at S16), the state machine 35 moves to S15 in order to set the synchronization determination to IF and set the accumulated hamming distance AHD to 0.

The state machine 35 that performs the first synchronization monitoring processing shifts the synchronization determination to IF when the synchronization pattern has been detected continuously at the time of synchronization pull-in. As a result, the transmission apparatus 2 may achieve pull-in from OOF to IF.

When the synchronization pattern has not been detected at the frame timing, the state machine 35 calculates the hamming distance HD of the synchronization pattern of the frame timing and accumulates the hamming distance HD to calculate the accumulated hamming distance AHD. When the accumulated hamming distance AHD has exceeded the threshold THD, the state machine 35 shifts the synchronization determination to OOF. As a result, because there is a high risk of the second case where OOF actually occurs when the accumulated hamming distance AHD has exceeded the threshold THD, the transmission apparatus 2 may quickly detect OOF.

When the accumulated hamming distance AHD has not exceeded the threshold THD, the state machine 35 continues IF as the synchronization determination. As a result, because the case merely is the third case where a minor bit error occurs when the accumulated hamming distance AHD has not exceeded the threshold THD, the transmission apparatus 2 may suppress erroneous detection of OOF by continuing IF as the synchronization determination without rashly shifting to OOF.

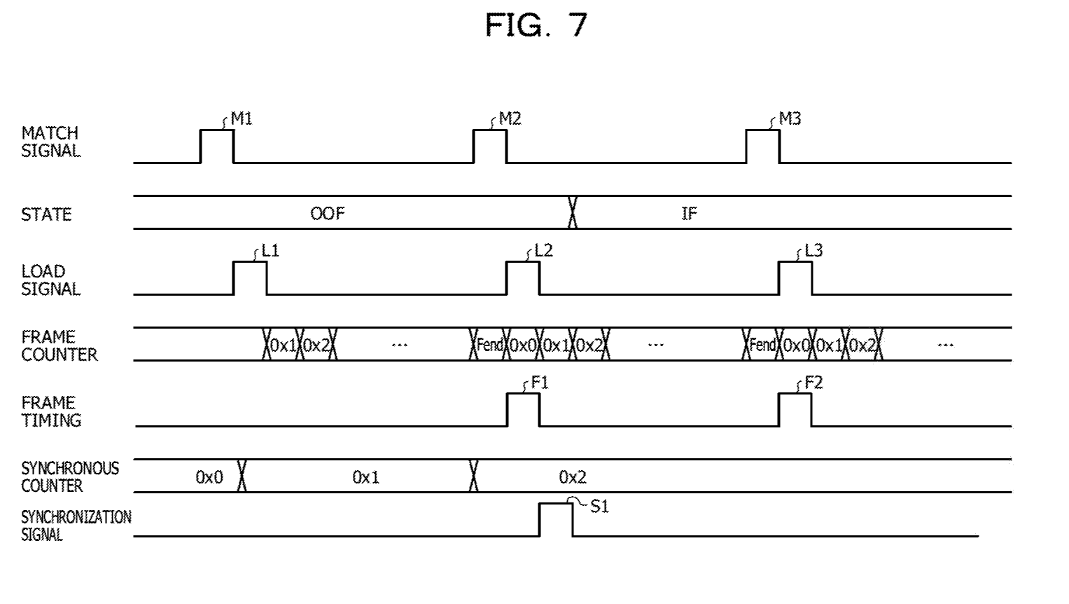

FIG. 7 is a timing diagram illustrating an example of each signal in the first synchronization determination unit 24 at the time of synchronization pull-in according to the first embodiment. When a bit stream of the synchronization pattern in the reception frame and the expected value perfectly match each other, the first comparison unit 32 outputs a first match signal M1. At this time, the state machine 35 shifts the state of the synchronization determination to OOF in accordance with the match signal M1 and outputs a load signal L1 in accordance with the match signal M1 to the synchronous counter 33 and the frame counter 34.

The frame counter 34 starts a count operation of the frame timing in accordance with the load signal L1. Furthermore, the synchronous counter 33 counts the synchronization pattern 0x1 in accordance with the match signal M1.

The first comparison unit 32 outputs a next match signal M2. At this time, the state machine 35 outputs a load signal L2 in accordance with the match signal M2. The synchronous counter 33 counts the synchronization pattern 0x2 in accordance with the match signal M2, delays the match signal M2 by one clock, and when the match signal M2 and a frame timing F1 at the frame counter 34 match each other, outputs a synchronization signal S1 to the state machine 35. As a result, the state machine 35 shifts the synchronization determination from OOF to IF in accordance with the synchronization signal S1. With this, the synchronization pull-in operation is completed. The first comparison unit 32 then outputs a next match signal M3. At this time, the state machine 35 outputs a load signal L3 in accordance with a match signal M3. Furthermore, the synchronous counter 33 counts the synchronization pattern 0x3 in accordance with the match signal M3.

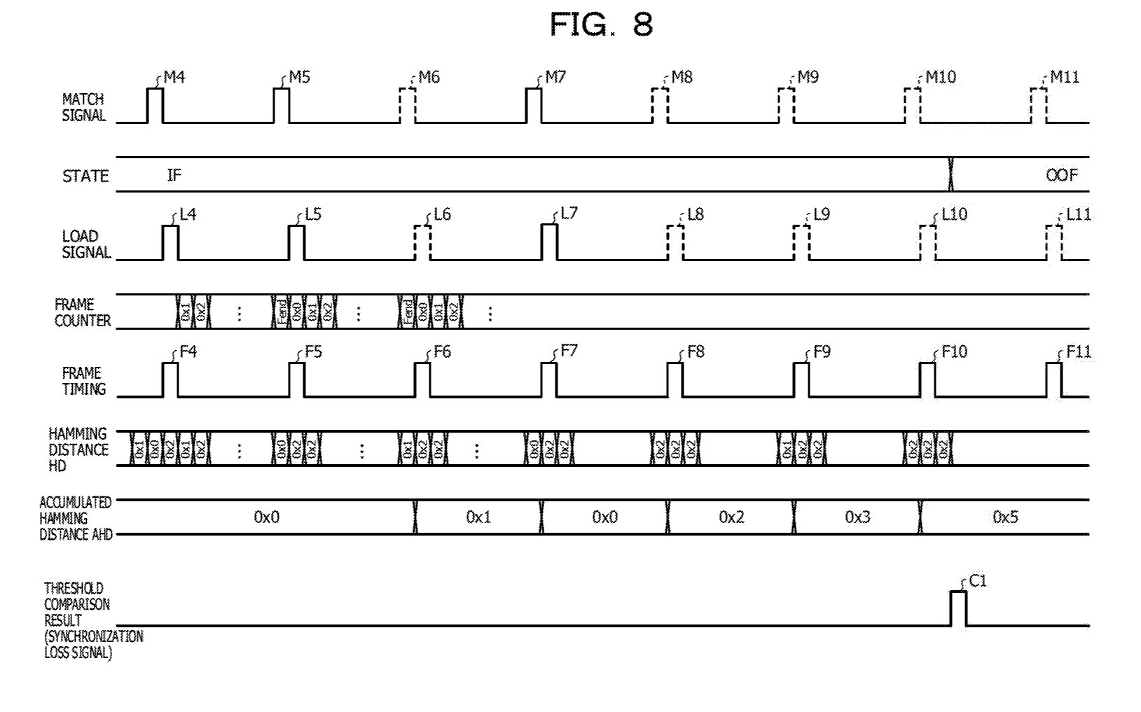

FIG. 8 is a timing diagram illustrating an example of each signal in the first synchronization determination unit 24 at the time of OOF according to the first embodiment. The example in FIG. 8 is an example of an operation until shifting to OOF during continuation of IF as the synchronization determination. For the convenience of explanation, description is made on the assumption that the predetermined threshold is “4”.

The state machine 35 outputs a load signal L4 in accordance with the match signal M4 from the first comparison unit 32. The distance calculation unit 36 calculates “0” as the hamming distance HD of the synchronization pattern of the timing of the match signal M4. The accumulation unit 37 accumulates the hamming distance HD of “0” on the accumulated hamming distance AHD. Furthermore, the accumulation unit 37 resets the accumulated hamming distance AHD in accordance with the load signal L4 from the state machine 35.

Next, the state machine 35 outputs a load signal L5 in accordance with a match signal M5 from the first comparison unit 32. The distance calculation unit 36 calculates “0” as the hamming distance HD of the synchronization pattern of the timing of the match signal M5. The accumulation unit 37 accumulates the hamming distance HD of “0” on the accumulated hamming distance AHD. Furthermore, the accumulation unit 37 resets the accumulated hamming distance AHD in accordance with the load signal L5 from the state machine 35.

The first comparison unit 32 does not output a match signal M6 because the bit stream of the synchronization pattern and the expected value do not perfectly match each other. The distance calculation unit 36 calculates “1” as the hamming distance HD between the bit stream and the expected value. The accumulation unit 37 accumulates the hamming distance HD of “1” on the accumulated hamming distance AHD. Because the accumulated hamming distance AHD has not exceeded the predetermined threshold THD, the second comparison unit 38 does not output a comparison result.

The state machine 35 outputs a load signal L7 in accordance with a match signal M7 from the first comparison unit 32. The distance calculation unit 36 calculates “0” as the hamming distance HD of the synchronization pattern of the timing of the match signal M7. The accumulation unit 37 accumulates the hamming distance HD of “0” on the accumulated hamming distance AHD. Furthermore, the accumulation unit 37 resets the accumulated hamming distance AHD in accordance with the load signal L7 from the state machine 35.

The first comparison unit 32 does not output a match signal M8 because the bit stream of the synchronization pattern and the expected value do not perfectly match each other. The distance calculation unit 36 calculates “2” as the hamming distance HD between the bit stream and the expected value. The accumulation unit 37 accumulates the hamming distance HD of “2” on the accumulated hamming distance AHD “0”. Because the accumulated hamming distance AHD “2” has not exceeded the predetermined threshold THD “4”, the second comparison unit 38 does not output a comparison result.

Next, the first comparison unit 32 does not output a match signal M9 because the bit stream of the synchronization pattern and the expected value do not perfectly match each other. The distance calculation unit 36 calculates “1” as the hamming distance HD between the bit stream and the expected value. The accumulation unit 37 accumulates the hamming distance HD of “1” on the accumulated hamming distance AHD “2”. Because the accumulated hamming distance AHD “3” has not exceeded the predetermined threshold THD “4”, the second comparison unit 38 does not output a comparison result.

Next, the first comparison unit 32 does not output a match signal M10 because the bit stream of the synchronization pattern and the expected value do not perfectly match each other. The distance calculation unit 36 calculates “2” as the hamming distance HD between the bit stream and the expected value. The accumulation unit 37 accumulates the hamming distance HD of “2” on the accumulated hamming distance AHD “3”. Because the accumulated hamming distance AHD “5” has exceeded the predetermined threshold THD “4”, the second comparison unit 38 outputs a comparison result C1 to the state machine 35. As a result, the state machine 35 shifts the synchronization determination from IF to OOF in accordance with the comparison result C1 and starts the synchronization pull-in operation.

In the second case, the bit stream of the synchronization pattern in the reception frame and the expected value do not match each other with respect to a half of the bits stochastically. The first synchronization determination unit 24 thus accumulates the hamming distance HD on the accumulated hamming distance AHD. For example, because the number of bits in the synchronization pattern is 24 bits by the OTN standard, the first synchronization determination unit 24 accumulates the hamming distance HD corresponding to 12 bits, which is half of the above-described number, on the accumulated hamming distance AHD. The accumulated hamming distance AHD then exceeds the threshold THD (for example, 7 times). As a result, in the second case, the first synchronization determination unit 24 may immediately shift the synchronization determination to OOF and start the synchronization pull-in operation.

In the third case, in the synchronization pattern in the reception frame, a minor bit error, for example, an error of one bit is dominant stochastically. The first synchronization determination unit 24 thus accumulates the hamming distance HD “1” on the accumulated hamming distance AHD. Because the accumulated hamming distance AHD does not easily exceed the threshold THD, the first synchronization determination unit 24 does not rashly shift the synchronization determination to OOF and continues IF. As a result, in the third case, because the hamming distance HD accumulated for each frame is around 1 and does not easily exceed the threshold THD, erroneous detection of OOF may be suppressed.

The transmission apparatus 2 according to the first embodiment calculates the hamming distance HD of the synchronization pattern of the frame timing, sequentially accumulates the hamming distance HD on the accumulated hamming distance AHD, and when the accumulated hamming distance AHD has exceeded the threshold THD, shifts the synchronization determination to OOF. As a result, because there is a high risk that OOF actually occurs, the transmission apparatus 2 may quickly detect OOF.

When the accumulated hamming distance AHD has not exceeded the threshold THD, the transmission apparatus 2 shifts the synchronization determination to IF. As a result, because only a minor bit error occurs, the transmission apparatus 2 continues IF as the synchronization determination without rashly shifting to OOF, whereby erroneous detection of OOF may be suppressed.

When the accumulated hamming distance AHD is small, the transmission apparatus 2 increases the number of frames before OOF is determined. By contrast, when the accumulated hamming distance AHD is large, the transmission apparatus 2 decreases the number of frames before OOF is determined. Accordingly, in the second case, OOF may be detected with high accuracy. In the third case, erroneous detection of OOF may be suppressed.

The first comparison unit 32 according to the first embodiment compares the bit stream of the synchronization pattern in the reception frame and the expected value, and when the bit stream and the expected value perfectly match each other, outputs a match signal. However, instead of a match signal, the hamming distance HD between the bit stream and the expected value may be output. An embodiment for this case will be described below as a second embodiment.

### Second Embodiment

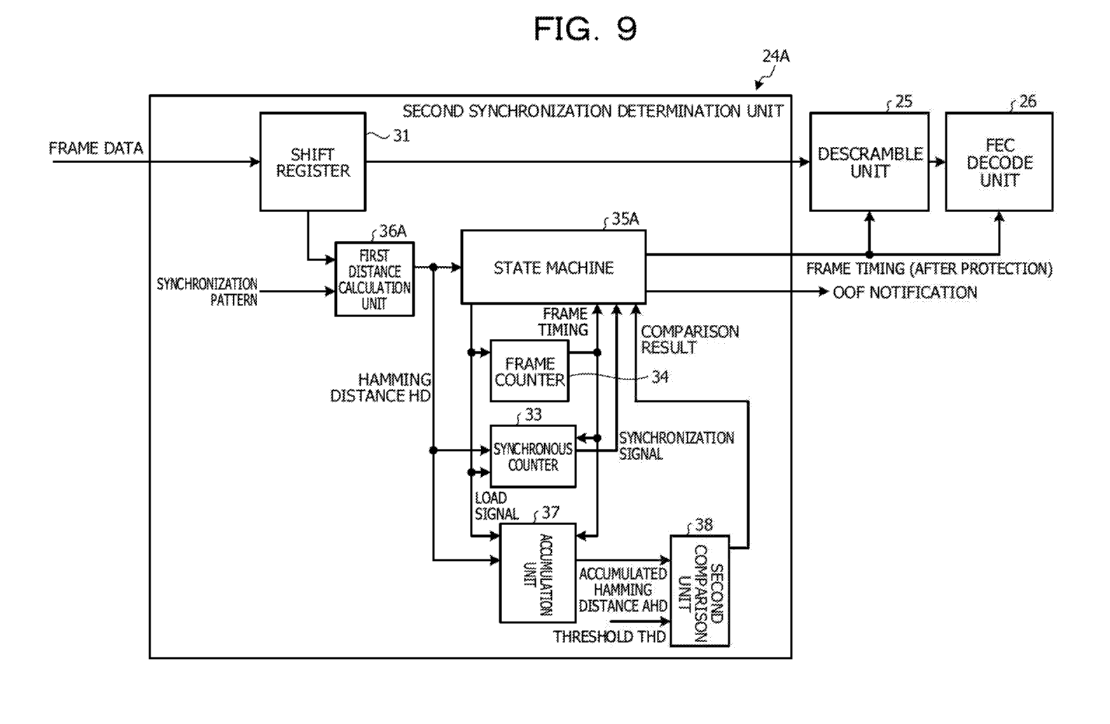

FIG. 9 is a block diagram illustrating an example of a configuration in a second synchronization determination unit 24A according to the second embodiment. A component having the same structure as that in the transmission apparatus 2 according to the first embodiment is denoted with the same reference numeral, and any overlapped explanation of the structure and operation thereof will be omitted. The difference between the first synchronization determination unit 24 and the second synchronization determination unit 24A is that instead of the first comparison unit 32 and the distance calculation unit 36, a first distance calculation unit 36A is arranged in the second synchronization determination unit 24A.

The first distance calculation unit 36A compares a bit stream of the synchronization pattern in the reception frame from the shift register 31 and an expected value of a predetermined synchronization pattern. The first distance calculation unit 36A compares the bit stream and the expected value and outputs the hamming distance HD which is a result of the comparison to a state machine 35A, the synchronous counter 33, and the accumulation unit 37. When the hamming distance HD is 0, the synchronous counter 33 counts detection of a synchronization pattern. Furthermore, when the synchronization patterns are continuously detected, the synchronous counter 33 outputs a synchronization signal to the state machine 35A.

The accumulation unit 37 accumulates the hamming distance HD on the accumulated hamming distance AHD and outputs the accumulated hamming distance AHD to the second comparison unit 38. The second comparison unit 38 compares the accumulated hamming distance AHD from the accumulation unit 37 and the threshold THD and outputs a comparison result to the state machine 35A.

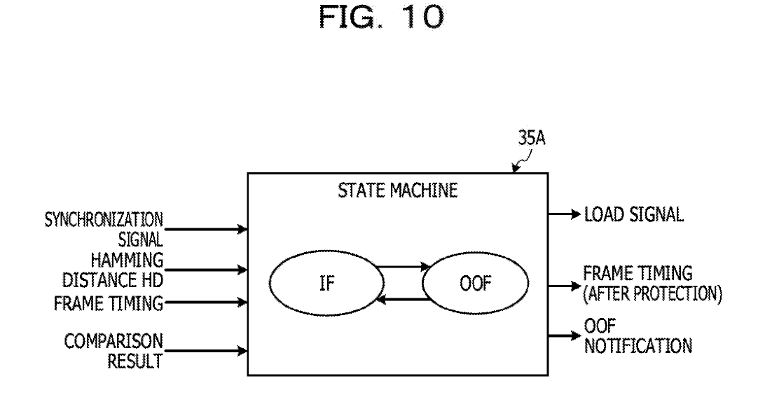

FIG. 10 is an explanatory diagram illustrating an example of a state shift of the state machine 35A. When the state machine 35A illustrated in FIG. 10 detects a comparison result indicating that the accumulated hamming distance AHD has exceeded the threshold THD, the state machine 35A shifts the synchronization determination to 00F. When the state machine 35A does not detect the comparison result indicating that the accumulated hamming distance AHD has exceeded the threshold THD, the state machine 35A continues IF as the synchronization determination.

When the hamming distance HD is 0, the state machine 35A outputs a load signal to the frame counter 34, the synchronous counter 33, and the accumulation unit 37. The frame counter 34 and the synchronous counter 33 perform reset in accordance with the load signal. The accumulation unit 37 sets the accumulated hamming distance AHD to 0 in accordance with the load signal.

When the synchronization determination is shifted to 00F, the second synchronization determination unit 24A starts the synchronization pull-in operation again. Furthermore, when the second synchronization determination unit 24A detects a synchronization signal from the synchronous counter 33, the second synchronization determination unit 24A shifts the synchronization determination of the reception frame to IF. When the synchronization determination is IF, as long as the hamming distance HD between the bit stream of the synchronization pattern in the reception frame and the expected value is 0 at the first distance calculation unit 36A, the second synchronization determination unit 24A continues IF as the synchronization determination.

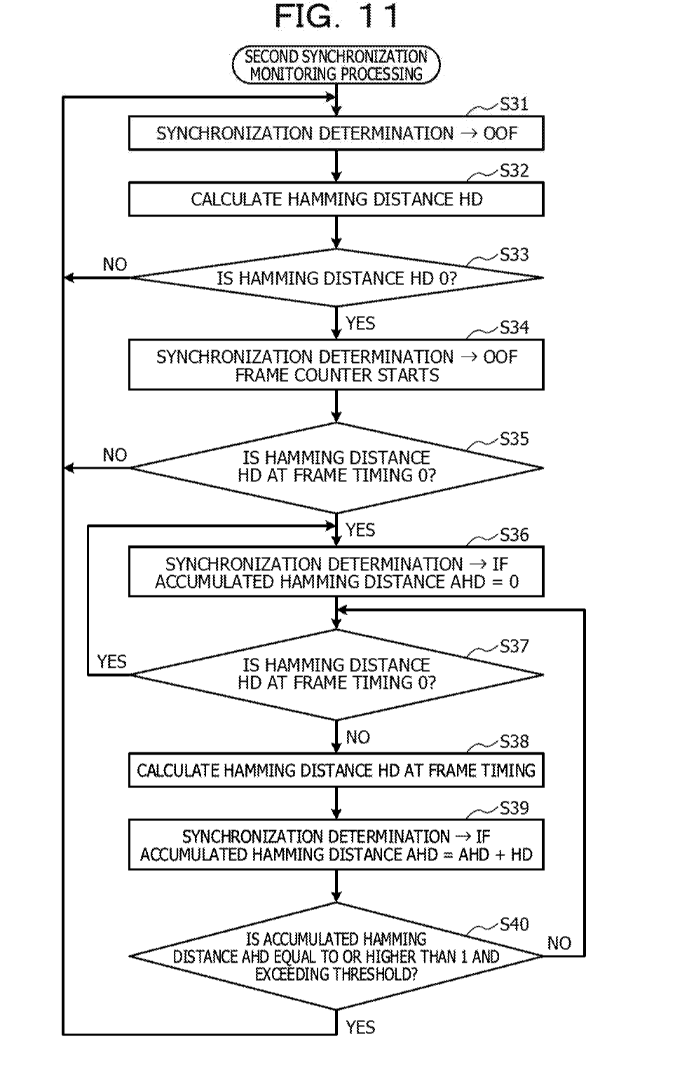

Next, an operation of the transmission apparatus 2 according to the second embodiment will be described. FIG. 11 is a flowchart illustrating an example of a processing operation of the second synchronization determination unit 24A related to second synchronization monitoring processing. The second synchronization monitoring processing is processing for detecting the synchronization pattern using the hamming distance HD, accumulating the hamming distance HD of the synchronization pattern, and when the accumulated hamming distance AHD equals to a predetermined threshold THD, shifting the synchronization determination to OOF.

The state machine 35A of the second synchronization determination unit 24A, as the synchronization pull-in operation, shifts the synchronization determination to OOF (S31). The first distance calculation unit 36A then calculates the hamming distance HD (S32). The state machine 35A determines whether the hamming distance HD is 0 (S33). When the hamming distance HD is 0 (Yes at S33), the state machine 35A sets the synchronization determination to OOF and starts a count operation at the frame counter 34 (S34).

The state machine 35A determines whether the hamming distance HD of the bit stream of the frame timing at the frame counter 34 is 0 (S35). When the hamming distance HD is 0 (Yes at S35), the state machine 35A sets the synchronization determination to IF and sets the accumulated hamming distance AHD to 0 (S36). Furthermore, the state machine 35A determines whether the hamming distance HD of the bit stream of the frame timing at the frame counter 34 is 0 (S37). When the hamming distance HD of the bit stream of the frame timing at the frame counter 34 is 0 (Yes at S37), the state machine 35A moves to S36 in order to set the synchronization determination to IF and set the accumulated hamming distance AHD to 0.

When the hamming distance HD of the bit stream of the frame timing is not 0 (No at S37), the state machine 35A calculates the hamming distance HD of the bit stream of the frame timing (S38). Furthermore, the state machine 35A sets the synchronization determination to IF and accumulates the hamming distance HD on the accumulated hamming distance AHD (S39). The state machine 35A then determines whether the accumulated hamming distance AHD is equal to or higher than 1 and has exceeded the threshold THD (S40).

When the accumulated hamming distance AHD is equal to or higher than 1 and has exceeded the threshold THD (Yes at S40), the state machine 35A moves to S31 in order to shift the synchronization determination to OOF. When the accumulated hamming distance AHD is equal to or higher than 1 and has not exceeded the threshold THD (No at S40), the state machine 35A moves to S37 in order to determine whether the hamming distance HD of the bit stream of the frame timing is 0.

When the hamming distance HD is not 0 (No at S33) or the hamming distance HD of the bit stream of the frame timing is not 0 (No at S35), the state machine 35A moves to S31 in order to shift the synchronization determination to OOF.

When the hamming distance HD of the bit stream of the frame timing at the time of the synchronization pull-in is 0, the state machine 35A that performs the second synchronization monitoring processing determines that the synchronization pattern is detected, and when the synchronization patterns are continuously detected, the state machine 35A shifts the synchronization determination to IF. As a result, the transmission apparatus 2 may achieve pull-in from OOF to IF as the synchronization determination.

When the hamming distance HD of the bit stream of the frame timing is not 0, the state machine 35A sequentially accumulates the hamming distance HD on the accumulated hamming distance AHD. The state machine 35A then determines whether that accumulated hamming distance AHD has exceeded the threshold THD. When the accumulated hamming distance AHD has exceeded the threshold THD, the state machine 35A shifts the synchronization state to OOF. As a result, because there is a high risk of the second case where OOF actually occurs when the accumulated hamming distance AHD has exceeded the threshold THD, the transmission apparatus 2 may quickly detect OOF.

When the accumulated hamming distance AHD has not exceeded the threshold THD, the state machine 35A continues IF as the synchronization determination. As a result, because the case merely is the third case where a minor bit error occurs when the accumulated hamming distance AHD has not exceeded the threshold THD, the transmission apparatus 2 may suppress erroneous detection of OOF by continuing IF as the synchronization determination without rashly shifting to OOF.

In the second case, the bit stream of the synchronization pattern in the reception frame and the expected value do not match each other with respect to a half of the bits stochastically. The second synchronization determination unit 24A thus accumulates the hamming distance HD on the accumulated hamming distance AHD. For example, because the number of bits in the synchronization pattern is 24 bits by the OTN standard, the second synchronization determination unit 24A accumulates the hamming distance HD corresponding to 12 bits, which is half of the above-described number, on the accumulated hamming distance AHD. The accumulated hamming distance AHD then exceeds the threshold THD (for example, 7 times). As a result, the second synchronization determination unit 24A may immediately shift the synchronization determination to OOF and start the synchronization pull-in operation.

In the third case, in the synchronization pattern in the reception frame, a minor bit error, for example, an error of one bit is dominant stochastically. The second synchronization determination unit 24A thus accumulates the hamming distance HD “1” on the accumulated hamming distance AHD. Because the accumulated hamming distance AHD does not easily exceed the threshold THD, the second synchronization determination unit 24A does not rashly shift the synchronization determination to OOF and continues IF. As a result, in the third case, because the hamming distance HD accumulated for each frame is around 1 and does not easily exceed the threshold THD, erroneous detection of OOF may be suppressed.

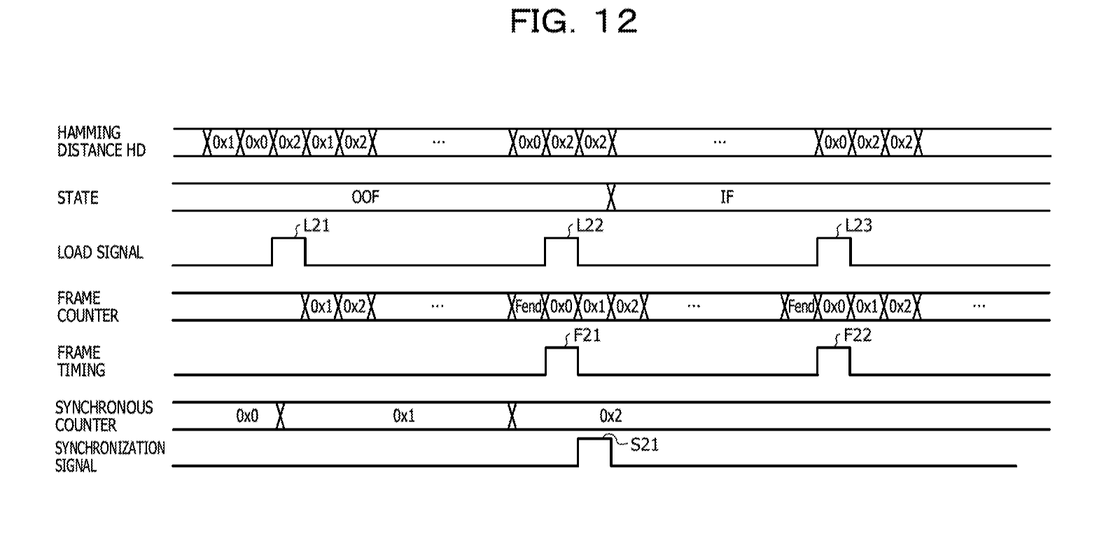

FIG. 12 is a timing diagram illustrating an example of each signal in the second synchronization determination unit 24A at the time of synchronization pull-in according to the second embodiment. The first distance calculation unit 36A calculates the hamming distance HD between the bit stream of the synchronization pattern in the reception frame and the expected value. The first distance calculation unit 36A then outputs the hamming distance HD to the synchronous counter 33, the accumulation unit 37, and the state machine 35A. At this time, when the hamming distance HD is “0”, the state machine 35A shifts the state of the synchronization determination to OOF. The state machine 35A then outputs a load signal L21 to the synchronous counter 33 and the frame counter 34.

The frame counter 34 starts a count operation of the frame timing in accordance with the load signal L21. Furthermore, when the hamming distance HD is “0”, the synchronous counter 33 counts the synchronization pattern 0x1.

When the next hamming distance HD is “0”, the state machine 35A outputs a load signal L22. Furthermore, when the hamming distance HD is “0”, the synchronous counter 33 counts the synchronization pattern 0x2 and delays the timing at which the hamming distance HD is “0” by one clock. When that timing and a frame timing F21 at the frame counter 34 match each other, the synchronous counter 33 further outputs a synchronization signal S21 to the state machine 35A.

As a result, the state machine 35A shifts the synchronization determination from OOF to IF in accordance with the synchronization signal S21. With this, the synchronization pull-in operation is completed.

The transmission apparatus 2 according to the second embodiment calculates the hamming distance HD of the bit stream of the frame timing, sequentially accumulates the hamming distance HD on the accumulated hamming distance AHD, and when the accumulated hamming distance AHD has exceeded the threshold THD, shifts the synchronization determination to OOF. As a result, because there is a high risk that OOF actually occurs, the transmission apparatus 2 may quickly detect OOF.

When the accumulated hamming distance AHD has not exceeded the threshold THD, the transmission apparatus 2 shifts the synchronization determination to IF. As a result, because only a minor bit error occurs, the transmission apparatus 2 continues IF as the synchronization determination without rashly shifting to OOF, whereby erroneous detection of OOF may be suppressed.

In the transmission apparatus 2 according to the second embodiment, the first comparison unit 32 and the distance calculation unit 36 according to the first embodiment may be substituted by one unit of the first distance calculation unit 36A, whereby the circuit scale thereof may be downsized.

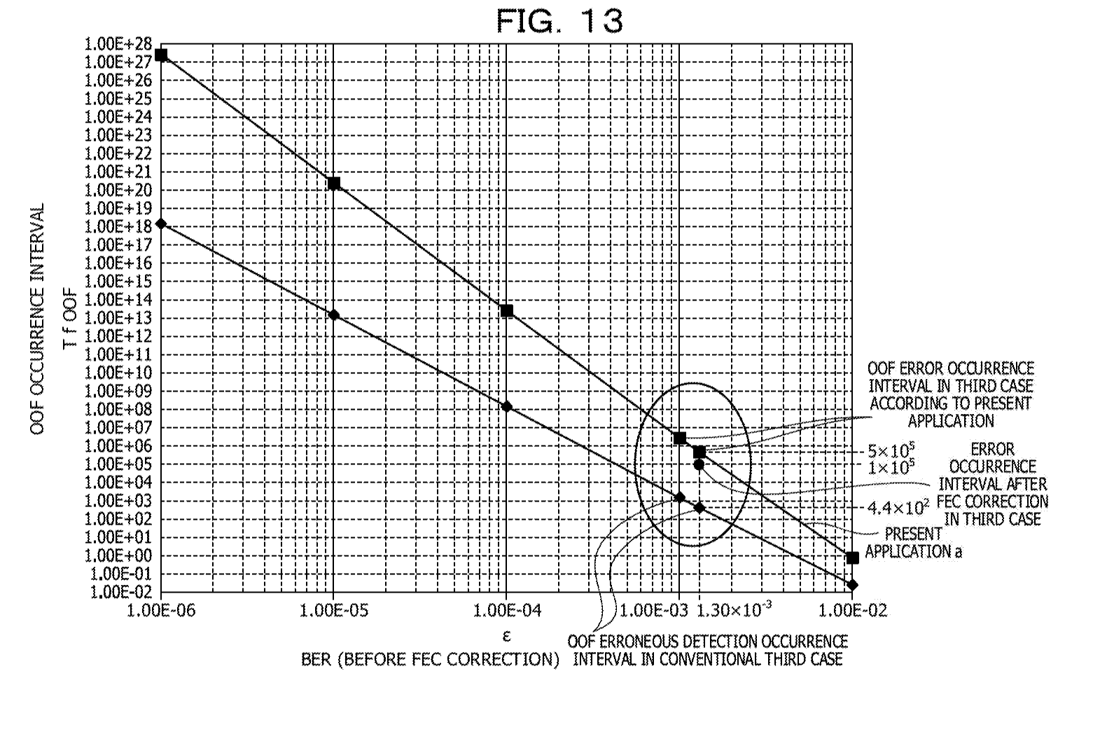

FIG. 13 is an explanatory diagram illustrating an example of a relation between a BER before FEC correction and an OOF occurrence interval. For example, with respect to a FEC code specified by ITU-T G.975.1 I7, a relation between a bit error rate before FEC correction (input BER) and a bit error rate after FEC correction (output BER) is input BER=1.30×10⁻³ and output BER=1×10⁻¹⁵. When transmission with an OTU2 frame (about 10 Gbps) is assumed, the average time interval at which bit errors occur is 1×10⁵ [seconds]. By contrast, by the conventional OTN synchronization determination specified by ITU-T G.798, under the same input BER environment and in the third case, the average occurrence interval of erroneous detection of OOF is 4.4×10² [seconds]. In this case, under an environment under which BER is high, erroneous detection of OOF in the third case occurs at a higher rate than that of a bit error after FEC correction. For example, with input BER=1.30×10⁻³ and when the threshold THD is set to “7”, the average occurrence interval of OOF in the third case is 5×10⁵ [seconds]. This may be longer than the occurrence interval of an error after FEC correction (the average occurrence interval: 1×10⁵ [seconds]). In other words, the average occurrence interval of OOF in the third case according to the present application is longer than those of OOF in the third case and OOF after BER correction with a conventional technique, whereby the frequency of shifting to OOF in the third case may be reduced.

The NWIF 12 in the above-described embodiments is communicably connected with an OTN, and thus includes the frame generation unit 21, the FEC encode unit 22, the scramble unit 23, the first synchronization determination unit 24, the descramble unit 25, the FEC decode unit 26, and the frame processing unit 27 embedded therein. However, the CLIF 11 also includes the frame generation unit 21, the FEC encode unit 22, the scramble unit 23, the first synchronization determination unit 24, the descramble unit 25, the FEC decode unit 26, and the frame processing unit 27 embedded therein when the CLIF 11 is communicably connected with an OTN.

At S18 in the first synchronization monitoring processing illustrated in FIG. 6, the synchronization determination is set to IF and the hamming distance HD is accumulated on the accumulated hamming distance AHD. However, the hamming distance HD may be accumulated on the accumulated hamming distance AHD at S18, and at S19, when the accumulated hamming distance AHD is equal to or higher than 1 and has not exceeded the threshold THD, the synchronization determination may be set to IF, and then the processing may move to S16.

At S39 in the second synchronization monitoring processing illustrated in FIG. 11, the synchronization determination is set to IF and the hamming distance HD is accumulated on the accumulated hamming distance AHD. However, the hamming distance HD may be accumulated on the accumulated hamming distance AHD at S39, and at S40, when the accumulated hamming distance AHD is equal to or higher than 1 and has not exceeded the threshold THD, the synchronization determination may be set to IF, and then the processing may move to S37.

In the above-described embodiments, an OTN frame and a SONET/SDH frame are assumed. However the embodiments are not limited to these communication networks. The above-described embodiments may be applied to a transmission apparatus 2 with a system that uses a synchronization pattern of a reception frame to detect synchronization loss.

In the above-described embodiments, when the accumulated hamming distance AHD has not exceeded the threshold THD at the second comparison unit 38, a comparison result is not output. However, the comparison result may be output to the state machine 35.

Each component in each unit illustrated does not necessarily have to be configured as illustrated physically. More specifically, the specific mode of distribution and integration of the unit is not limited to the illustrated one, and all or a part thereof may be configured in a functionally or physically distributed or integrated manner in an arbitrary unit, in accordance with various loads, use conditions, and the like.

Furthermore, with respect to each of various processing functions executed in each apparatus, all or an arbitrary part thereof may be executed on a central processing unit (CPU), a digital signal processor (DSP), a field programmable gate array (FPGA), and the like. With respect to each of the processing functions, all or an arbitrary part thereof may be executed on a program analyzed and executed on a CPU or the like or on hardware using a wired logic.

A region for storing therein various information may be composed of a read only memory (ROM) or a random access memory (RAM) such as synchronous dynamic random access memory (SDRAM), a magnetoresistive random access memory (MRAM), and a non-volatile random access memory (NVRAM).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A synchronization detection method executed by a processor included in a transmission apparatus, the synchronization detection method comprising:
receiving a frame in accordance with a predetermined timing;
calculating an unmatched bit number that indicates a number of unmatched bits between a bit stream of the received frame and an expected bit stream that indicates a bit stream that has been expected to be received;
acquiring an accumulated number by accumulating the unmatched bit number at the predetermined timing;
determining whether the received frame is synchronized with a predetermined signal by comparing the accumulated number and a predetermined threshold; and
starting processing for establishing synchronization between the received frame and the predetermined signal when it is determined that the received frame is not synchronized with the predetermined signal.

2. The synchronization detection method according to claim 1,
wherein the counting includes resetting the accumulated number when the unmatched bit number is zero.

3. The synchronization detection method according to claim 1,
wherein the calculating includes calculating a number of bits that indicates unmatching between a bit stream of a synchronization pattern in the received frame and the expected bit stream of the synchronization pattern.

4. The synchronization detection method according to claim 1, wherein the determining includes
determining whether the unmatched bit number is equal to or higher than 1 and has exceeded the predetermined threshold, and
determining that the received frame is not synchronized with the predetermined signal when it is determined that the unmatched bit number is equal to or higher than 1 and has exceeded the predetermined threshold.

5. The synchronization detection method according to claim 1,
wherein the transmission apparatus stores therein state information that indicates whether the received frame is in a synchronized state,
wherein the starting includes:
setting the state information to an unsynchronized state when it is determined that the received frame is synchronized with the predetermined signal, and
starting processing for establishing synchronization when the state information is set to the unsynchronized state.

6. The synchronization detection method according to claim 5, further comprising:
setting the state information to a synchronized state when it is determined that the received frame is synchronized with the predetermined signal.

7. The synchronization detection method according to claim 5, further comprising:
changing setting of the state information from the unsynchronized state to a synchronized state, when synchronization is established between the received frame and the predetermined signal.

8. A transmission apparatus comprising:
a memory; and
a processor coupled to the memory and configured to:
receive a frame in accordance with a predetermined timing;
calculate an unmatched bit number that indicates a number of unmatched bits between a bit stream of the received frame and an expected bit stream that indicates a bit stream that has been expected to be received;
acquire an accumulated number by accumulating the unmatched bit number at the predetermined timing;
determine whether the received frame is synchronized with a predetermined signal by comparing the accumulated number and a predetermined threshold; and
start processing for establishing synchronization between the received frame and the predetermined signal when it is determined that the received frame is not synchronized with the predetermined signal.

9. The transmission apparatus according to claim 8,
wherein the counting includes resetting the accumulated number when the unmatched bit number is zero.

10. The transmission apparatus according to claim 8,
wherein the processor is configured to calculate a number of bits that indicates unmatching between a bit stream of a synchronization pattern in the received frame and the expected bit stream of the synchronization pattern.

11. The transmission apparatus according to claim 8, wherein the processor is configured to:
determine whether the unmatched bit number is equal to or higher than 1 and has exceeded the predetermined threshold, and
determine that the received frame is not synchronized with the predetermined signal when it is determined that the unmatched bit number is equal to or higher than 1 and has exceeded the predetermined threshold.

12. The transmission apparatus according to claim 8,
wherein the transmission apparatus stores therein state information that indicates whether the received frame is in a synchronized state,
wherein the processor is configured to:
set the state information to an unsynchronized state when it is determined that the received frame is synchronized with the predetermined signal, and
start processing for establishing synchronization when the state information is set to the unsynchronized state.
